(19) United States
(12) Patent Application Publication
(10) Pub. No.: US 2025/0250742 A1
(43) Pub. Date: Aug. 7, 2025

(54) HIGHLY REFINED CELLULOSE PULP COMPOSITION WITH COMPRESSION REFINED CELLULOSE PULP

(71) Applicant: Stora Enso OYJ, Helsinki (FI)

(72) Inventors: Katja Lyytikäinen, Imatra (FI); Cecilia Land Hensdal, Forshaga (SE); Kaj Backfolk, Lappeenranta (FI); Isto Heiskanen, Imatra (FI)

(73) Assignee: Stora Enso OYJ, Helsinki (FI)

(21) Appl. No.: 18/855,665

(22) PCT Filed: Apr. 11, 2023
(86) PCT No.: PCT/IB2023/053668

§ 371 Date: Oct. 10, 2024

(30) Foreign Application Priority Data
Apr. 12, 2022 (SE) 2230110-5

(51) Int. Cl. D21H 11/18; B32B 29/00; C08J 5/18; C08K 11/00; C08L 1/02

(52) U.S. Cl. CPC D21H 11/18; B32B 29/005; C08J 5/18; C08K 11/00; C08L 1/02; B32B 2250/02; B32B 2307/7244; C08J 2301/02; C08L 2201/54; C08L 2205/16

(57) ABSTRACT

The present invention relates to a highly refined cellulose pulp (HRC) composition for preparation of barrier papers or films, said composition comprising: 50-99 wt % HRC having a Schopper-Riegler number (SR)>70, as measured according to the standard ISO 5267-1, and 1-50 wt % of compression refined cellulose pulp having a Schopper-Riegler number (SR)<30, as measured according to the standard ISO 5267-1, and a water retention value (WRV)>120%, as measured according to the standard ISO 23714, based on the total dry weight of the HRC composition. The invention further relates to an HRC paper or film and a multilayer material comprising the HRC composition.

### TECHNICAL FIELD

The present disclosure relates to highly refined cellulose pulp (HRC) compositions for preparation of papers or films useful, for example, as gas and/or grease barrier papers or films in paper and paperboard. The present invention further relates to films and multilayer materials comprising such HRC compositions and to methods for manufacturing such HRC compositions.

### BACKGROUND

Papers, films and coatings made from highly refined cellulose pulp (HRC) such as microfibrillated cellulose (MFC), have emerged as an interesting alternative to conventional gas barrier films, such as aluminum and synthetic polymer films and various laminates thereof. Films comprising HRC have been developed, in which cellulosic fibrils have been dispersed and/or suspended in aqueous media and thereafter re-organized and rebonded together to form a dense film with high barrier properties.

In addition to providing excellent gas barrier properties, HRC or MFC papers, films and coatings may also be inherently transparent or translucent to visible light, making them especially useful in applications where transparency or translucency of HRC layer in the visible light spectrum (typically in the range of 380 to 740 nm) is required.

HRC papers or films can be made by applying an HRC suspension on a porous substrate, for example a membrane or wire, forming a web followed by dewatering of the web by draining water through the substrate to form HRC paper or film. This can be accomplished e.g. by use of a paper- or paperboard machine type of process. US2012298319A teaches a method of manufacturing of an MFC film by applying a furnish comprising MFC directly on porous substrate thus allowing the MFC to be dewatered and filtered. However, highly refined pulp or high content of fine cellulose will exhibit high drainage resistance, which increases risks for web defects caused during dewatering or low material retention.

Alternatively, HRC paper or film can be made by use of casting technologies, including applying an HRC suspension onto a non-porous cast substrate, such as a polymeric or metal substrate, and drying said paper or film by evaporation and/or wet pressing. Films made by casting technologies usually provide a more uniform thickness distribution and a smoother surface. The publication EP2771390 A4 describes preparation of MFC films, in which an aqueous cellulose nanofiber dispersion is coated on a paper or polymeric substrate, dried and finally peeled off as a nanofiber film sheet. A problem with casting technologies compared to wire forming and dewatering is that they are less suited for high scale production.

Another problem with HRC and MFC papers or films is that they may be brittle and provide low strain ability and tear resistance since the fiber network formed from short fibers will not have the ability to stretch in the same way as longer fibers. When forming HRC papers or films of low grammage and thickness, the paper or film may easily break during wet web forming, converting or handling.

Various additives have been considered in order to address the problems associated with improving the mechanical properties of HRC papers or films. However, while the use of a given additive may solve one specific problem, it may not be able to solve or maintain other physical or mechanical requirements and may even cause new problems. As an example, the addition of longer cellulose fibers as reinforcement in the HRC papers or films may improve the mechanical properties of the papers or films but will at the same time impair the gas barrier properties and transparency or translucency of the paper or film. The addition of the reinforcement fibers may create a more irregular fiber network and increase the risk of pinhole formation. Other additives may adversely affect the re-use of the material such as in the form of broke or pre- or post-consumer reject.

Thus, there remains a need to solve the problem with drainage resistance when preparing barrier papers or films comprising HRC and to further improve the properties of HRC papers and films.

### DESCRIPTION OF THE INVENTION

It is an object of the present disclosure to provide an improved highly refined cellulose pulp (HRC) composition for preparation of barrier papers, films or coatings, which eliminates or alleviates at least some of the problems in the prior art.

It is a further object of the present disclosure to provide an HRC composition which enables the manufacturing of an HRC paper or film with good gas barrier properties and improved mechanical properties.

It is a further object of the present disclosure to enable the manufacturing of an HRC paper or film, which shows high oxygen barrier properties, is easy to handle, easy to produce at higher speeds, easy to convert, and/or makes use of more cost-efficient raw materials.

The above-mentioned objects, as well as other objects as will be realized by the skilled person in the light of the present disclosure, are achieved by the various aspects of the present disclosure.

The present disclosure is based on the inventive realization that compression refined cellulose fibers can be added to an HRC composition to improve the mechanical properties of HRC papers or films formed from the composition, while still maintaining the good gas barrier properties and transparency or translucency characteristic to HRC papers or films without added fibers. In compression refining, the applied shear on the fibers induces fiber wall defects rather than fiber cutting or surface fibrillation or defibrillation. Without wishing to be bound to any specific scientific theory, it is believed that the compression refined cellulose fibers have a higher tendency to collapse (due to chemical or mechanical damage of the fiber walls) as compared to unrefined or conventionally refined fibers. This leads to better formation and improved evenness of formed sheets, visual appearance, evenness of mechanical strength properties, etc. This also allows for a relatively high content of the compression refined fibers to be added to the HRC without inducing problems with the gas barrier properties of the formed films. The addition of compression refined cellulose fibers to the HRC composition may also reduce the need for other added formation, retention or drainage chemicals.

According to a first aspect illustrated herein, there is provided a highly refined cellulose pulp (HRC) composition for preparation of barrier papers or films, said composition comprising:
50-99 wt % HRC having a Schopper-Riegler number (SR)>70, as measured according to the standard ISO 5267-1, and
1-50 wt % of compression refined cellulose pulp having
   a Schopper-Riegler number (SR)<30, as measured according to the standard ISO 5267-1, and
   a water retention value (WRV)>120%, as measured according to the standard ISO 23714,
      based on the total dry weight of the HRC composition.

The HRC composition may be in the form of a solid composition, e.g. in the form of a dried or substantially dried paper, film, coating or powder, or it can be in the form of a suspension of the HRC composition in a liquid medium, preferably water.

In some embodiments, the HRC composition is a solid composition. The solid composition preferably has a moisture content of 20 wt % or less, preferably 15 wt % or less, more preferably 10 wt % or less.

In some embodiments, the HRC composition is an aqueous suspension. A composition in the form of an aqueous suspension can be used for the preparation of a paper, film or coating. In some embodiments, the consistency of the aqueous suspension is in the range of 0.1-50 wt %, preferably in the range of 0.2-30 wt %, and more preferably in the range of 0.3-20 wt %.

The drainability of the HRC composition will depend on the type and amount of HRC and compression refined fibers used, as well as other components added to the composition. In some embodiments, the HRC composition has a Schopper-Riegler (SR) number >20, preferably >30, and more preferably >40, as measured according to the standard ISO 5267-1. In some embodiments, the HRC composition has a Schopper-Riegler (SR) number <95, preferably <90, and more 5 preferably <88, as measured according to the standard ISO 5267-1.

The HRC composition may be comprised solely of a mixture of HRC and compression refined cellulose pulp, or it can comprise the mixture of HRC and compression refined cellulose pulp combined with other ingredients or additives. The HRC composition preferably includes HRC as its main component based on the total dry weight of the HRC composition. Specifically, the HRC composition comprises HRC at a concentration in the range of 50-99.9 wt %. In some embodiments, the HRC composition comprises in the range of 55-99 wt %, preferably in the range of 60-99 wt %, more preferably in the range of 65-98 wt % of HRC, based on the total dry weight of the HRC composition.

In some embodiments, the HRC has a Schopper-Riegler (SR) number >80, preferably >90, as measured according to the standard ISO 5267-1.

20 In some embodiments, the HRC is microfibrillated cellulose (MFC).

Microfibrillated cellulose (MFC) shall in the context of the present disclosure mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

In some embodiments, the HRC is unmodified HRC or chemically modified HRC, or a mixture thereof.

The HRC composition comprises 1-50 wt % of compression refined cellulose pulp, based on the total dry weight of the HRC composition. In some embodiments, the HRC composition comprises in the range of 1-40 wt %, preferably in the range of 1-30 wt %, more preferably in the range of 2-20 wt % of the compression refined cellulose pulp, based on the total dry weight of the HRC composition. The inventors have found that 1-30 wt % of compression refined cellulose pulp can be added to the HRC composition without affecting the barrier properties of films formed of the HRC composition. However, higher amounts may also be used if a slight deterioration of the barrier properties can be accepted.

In compression refining, also sometimes referred to as internal fibrillation refining or internal fibrillation, of the shear applied on the fibers induces fiber wall defects rather than fiber cutting or surface fibrillation or defibrillation. The fiber wall defects include fiber wall delamination and internal fibrillation. Preferably, the compression refining damages the fiber wall, while the fiber is fibrillated to very low degree. Ideally, there is no surface fibrillation at all.

The fiber wall damages cause the compression refined cellulose fibers to collapse more easily and gives sheets with higher density.

The fiber wall defects can be visualized directly by microscope. The lack of surface fibrillation can be demonstrated e.g. by staining the compression refined fibers such as with Simons' staining. The fiber wall defects may also be detected indirectly from fiber morphology analysis, e.g. using a Valmet FS5 fiber analyzer.

Compression refining may for example be done using vibration grinders, rubbing-shearing devices, and roll and abrasion devices. Examples of compression refiners include, but are not limited to, roll refiners, vibration refiners, vibration grinders, Lampen mills, rotor-rotor grinders or rotor-rotor mixers (using rotors rotating in opposite or same direction, for example Atrex G series from Megatrex), or compressive E-compactors.

Compression refining is preferably done at a consistency >3 wt %, and more preferably at a consistency >4 wt %. In order to facilitate the compression refining, it is preferable to increase the consistency to >5 wt %, >7 wt %, >9 wt %>12 wt % or >15 wt %.

Compression refining is preferably done at a pH value in the range of 5-11, and preferably in the range of 6-9.

Compression refining is preferably done at a temperature in the range of 20-85° C., preferably in the range of 30-70° C.

In some embodiments, the compression refined cellulose pulp has been subjected to alkali extraction or enzymatic treatment, for example using cellulases or hemicellulases or combinations thereof, before during and/or after the compression refining. Alkali extraction or enzymatic treatment activates the fibers and makes the fiber wall more susceptible to collapse or flattening and to introduction of fiber wall defects.

In some embodiments, a polysaccharide such as MFC or CMC is added to the cellulose pulp to be compression refined in an amount of 0.5-100 kg/tn based on dry weight. In a preferred embodiment, a mixture of CMC and MFC is added to the cellulose pulp to be compression refined.

The compression refined cellulose pulp may for example be compression refined cellulose pulp obtained from hardwood or softwood. In some embodiments, the compression refined cellulose pulp is compression refined kraft pulp.

The compression refined cellulose fibers are larger than the highly refined fibers of the HRC or microfibrils of the MFC. The size of the compression refined cellulose fibers may depend on the source of the fibers, e.g. hardwood or softwood. In some embodiments, the compression refined cellulose fibers of the HRC composition have a fiber width of 10 μm or more, as measured using an FS5 optical fiber analyzer (Valmet). In some embodiments, the compression refined cellulose fibers of the HRC composition have a fiber width in the range of 10-31 μm, preferably in the range of 10-29 μm, and more preferably in the range of 10-27 μm, as measured using an FS5 optical fiber analyzer (Valmet). The HRC is typically made up of cellulose having a significantly lower fiber width and MFC is typically made up of cellulose particle fibers or fibrils with at least one dimension in the range of 20-1000 nm.

The compression refined cellulose pulp is characterized by a very low Schopper-Riegler (SR) number, <30 as measured according to the standard ISO 5267-1 combined with a relatively high water retention value (WRV), >120%, as measured according to the standard ISO 23714.

In some embodiments, the compression refined cellulose pulp has a Schopper-Riegler (SR) number <20, preferably <15, as measured according to the standard ISO 5267-1. In some embodiments, the compression refined cellulose pulp has an even lower Schopper-Riegler (SR) number, such as <13 or <11, as measured according to the standard ISO 5267-1.

In some embodiments, the compression refined cellulose pulp has a water retention value (WRV)>130%, preferably >140%, and more preferably >150%, as measured according to the standard ISO 23714.

In some embodiments, the compression refined cellulose pulp has a water retention value (WRV)<210%, preferably <200%, and more preferably <190%, as measured according to the standard ISO 23714.

The compression refined cellulose pulp is also characterized by a high fiber curl value. In some embodiments, the compression refined cellulose pulp has a fiber curl value >10%, preferably >15%, and more preferably >20%, as determined using a FS5 fiber analyzer (Valmet).

In some embodiments, the compression refined cellulose pulp has a mean fiber length in the range of 0.2-4 mm, preferably in the range of 0.3-2 mm, more preferably in the range of 0.5-2 mm, as determined using a FS5 fiber analyzer (Valmet). Mean fiber length as used herein refers to the mean fiber length (Lc(n) ISO) measured according to the standard ISO 16065-2 using an FS5 optical fiber analyzer (Valmet).

The formulation of the HRC composition may vary depending on the intended use of the HRC composition and on the intended mode of application or formation of a paper, film or coating of the HRC composition. The HRC composition may include a wide range of ingredients in varying quantities to improve the end performance of a paper, film or coating of the HRC composition.

The HRC composition may further comprise additives such as starch, fillers, retention aids, flocculation additives, deflocculating additives, dry strength additives, softeners, lubricants, wet strength agents, crosslinkers, colorants or dyes, defoamers, fixatives, biocides, pH regulators, UV blocking agents, or mixtures thereof. The HRC composition may for example comprise additives that will improve different properties of the HRC composition and/or a paper, film or coating formed thereof, such as latex and/or polyvinyl alcohol (PVOH) for enhancing the ductility of the coating.

In some embodiments, the HRC composition further comprises a water-soluble polymer selected from the group consisting of a starch, a polyvinyl alcohol (PVOH), a cellulose derivative, a hemicellulose, a polyacrylamide, a polydiallyldimethylammonium chloride (PDADMAC), a polyvinylamine (PVAm), a polyethyleneimine (PEI), polyamideamine epichlorohydrin (PAE), a protein or a mixture thereof, preferably a PVOH.

In some preferred embodiments, the water-soluble polymer is a PVOH. The PVOH may be a single type of PVOH, or it can comprise a mixture of two or more types of PVOH, differing e.g. in degree of hydrolysis or viscosity or different functional groups. The PVOH may for example have a degree of hydrolysis in the range of 80-99 mol %, preferably in the range of 88-99 mol %. Furthermore, the PVOH may preferably have a viscosity above 5 mPaxs in a 4% aqueous solution at 20° C. as measured according to the standard DIN 53015/JIS K 6726.

In some embodiments, the HRC composition comprises in the range of 0.1-50 wt %, preferably in the range of 1-30 wt %, more preferably in the range of 1-10 wt % of the water-soluble polymer, based on the total dry weight of the HRC composition.

In some embodiments, the HRC composition further comprises a pigment. The pigment may for example comprise inorganic particles of talcum, silicates, carbonates, alkaline earth metal carbonates and ammonium carbonate, or oxides, such as transition metal oxides and other metal oxides. The pigment may also comprise nano-size pigments such as nanoclays and nanoparticles of layered mineral silicates, for instance selected from the group comprising montmorillonite, bentonite, kaolinite, hectorite and hallyosite.

In order to retain the gas barrier properties of the papers or films or coatings formed of the HRC composition, the particle size and the concentration of the pigments should preferably be low. In some embodiments, the pigment is selected from the group consisting of nanoclays and nanoparticles of layered mineral silicates, more preferably bentonite.

In some embodiments, the HRC composition comprises in the range of 0.1-20 wt %, preferably in the range of 0.5-15 wt %, more preferably in the range of 1-10 wt % of the pigment, based on the total dry weight of the HRC composition.

The HRC composition of the first aspect described above is useful in the preparation of HRC papers or films, useful for example as barrier films in paper or paperboard based packaging laminates. The improved drainability of the inventive HRC composition as compared to a similar HRC composition without the compression refined cellulose pulp, e.g. an HRC composition consisting entirely of HRC, allows for faster dewatering of films formed of the HRC composition and reduces the risks for web defects caused during dewatering. The obtained films have good gas barrier properties and improved mechanical properties as compared to a similar HRC paper or film formed from an HRC composition without the compression refined cellulose pulp.

Thus, according to a second aspect illustrated herein, there is provided an HRC paper or film comprising an HRC composition as defined herein with reference to the first aspect.

The term “HRC paper or film” as used herein refers generally to a thin continuous sheet formed material formed of highly refined cellulose pulp (HRC) as the main component based on dry weight. Depending on the fiber composition of the HRC paper or film, it can be seen either as a paper or as a film.

The HRC paper or film may be a free-standing HRC paper or film, an HRC coating on a substrate, or an HRC layer of a multilayer material. The HRC paper or film may for example be prepared by wire forming and dewatering, casting, coating or wet laid process.

A free-standing paper or film should preferably have sufficient thickness, mechanical strength and rigidity in order for it to be handled, e.g. reeled, unreeled, coated, and/or laminated to a paper or paperboard substrate. In some embodiments, the HRC paper or film has a grammage in the range of 10-100 g/m², preferably in the range of 12-50 g/m², more preferably in the range of 15-40 g/m².

In some embodiments, the HRC paper or film is instead a coating layer on a paper or paperboard substrate. When the paper or film is formed, or coated, on a paper or paperboard substrate followed by dewatering and drying, the resulting HRC paper or film may be seen as a coating layer on the paper or paperboard substrate. An HRC paper or film in the form of a coating layer on a paper or paperboard substrate can be made significantly thinner than a free-standing HRC paper or film, since mechanical strength and rigidity for handling can be provided by the paper or paperboard substrate. Accordingly, in some embodiments, an HRC paper or film in the form of a coating can have a grammage in the range of 1-30 g/m², preferably in the range of 1-20 g/m², or more preferably in the range of 1-10 g/m².

In some embodiments, the HRC paper or film has a density >750 kg/m³, preferably >850 kg/m³, and more preferably >900 kg/m³. If the HRC paper or film is calendered, the density may be even higher.

The present disclosure is based on the inventive realization that compression refined cellulose fibers can be used to improve the mechanical properties and flexibility of HRC paper or films, while still maintaining the good gas barrier properties characteristic to HRC paper or films without added natural or synthetic fibers which cause reduced barrier properties. The addition of the compression refined cellulose pulp in the HRC paper or film improves the mechanical strength of the paper or film as compared to a corresponding HRC paper or film without the compression refined cellulose pulp, i.e. in which the compression refined cellulose fibers are replaced by HRC. In some embodiments, HRC paper or film has a tear index at least 5% higher, preferably at least 10% higher, more preferably at least 15% higher, than the tear index of a corresponding paper or film formed entirely of the same type of HRC used in the HRC composition, as measured according to the standard ISO 1974.

In some embodiments, HRC paper or film has an oxygen transfer rate (OTR), as measured according to the standard ASTM F-1927-98 at 50% relative humidity and 23° C., of less than 30 cc/m²/24 h/atm, and preferably less than 20 cc/m²/24 h/atm.

In some embodiments, HRC paper or film has a KIT value above 10, as measured according to standard TAPPI T559.

In some embodiments, the HRC paper or film has a transparency of at least 75%, preferably at least 80%, as measured according to the standard DIN 53147. The transparency of the HRC paper or film may depend on the amount of compression refined cellulose pulp.

In some embodiments, HRC paper or film has a PPS surface smoothness <5 μm, preferably <4 μm, and more preferably <3 μm, as determined according to ISO 8791-4:2007.

The inventive HRC paper or films or coatings are often used as a barrier layer in a multilayer material, such as a paper or paperboard based packaging laminate comprised of two or more plies.

According to a third aspect illustrated herein, there is provided a multilayer material comprising at least:
a substrate layer and
an HRC layer comprising an HRC composition as defined herein with reference to the first aspect.

In some embodiments, the HRC layer is an HRC paper or film as described above with reference to the second aspect.

In the multilayer material, the HRC layer may be attached to the substrate layer directly, or via one or more intermediate layers. For example, the HRC layer may be coated or wet laid directly onto the substrate layer, or an HRC paper or film may be laminated to the substrate layer using an intermediate adhesive layer.

In some embodiments, the substrate layer is paper or paperboard.

In some embodiments, the paper or paperboard has a basis weight in the range of 20-500 g/m², preferably in the range of 80-400 g/m².

In some embodiments, the multilayer material is a paper or paperboard comprised of two or more plies, wherein at least one ply comprises an HRC composition as described above with reference to the first aspect.

In some embodiments, the at least one ply comprising an HRC composition is an HRC paper or film as described above with reference to the second aspect.

In some embodiments, the multilayer material further comprises one or more heat sealable layers, such as one or more polyethylene layers.

The HRC suspensions comprising the compression refined cellulose pulp are easier to dewater and have improved strength and runnability, e.g. in converting machines, as compared to HRC suspensions without the compression refined cellulose pulp.

According to a fourth aspect illustrated herein, there is provided a method of preparing an HRC paper or film, said method comprising:
a) preparing an aqueous suspension of an HRC composition as defined herein with reference to the first aspect;
b) forming a web of the aqueous HRC composition; and
c) allowing the web to dry to obtain the HRC paper or film.

The aqueous suspension of the HRC composition may be prepared in a number of different ways. The aqueous suspension of the HRC composition may for example be prepared by mixing dry HRC and dry compression refined cellulose pulp and dispersing the dry mixture in water, or by adding compression refined cellulose pulp to an aqueous HRC suspension. The compression refined cellulose pulp can be added dry or in high consistency form. High consistency form means that the consistency of the suspension is higher than 5 wt % preferably higher than 10 wt %, and more preferably higher than 15 wt %.

In some embodiments of the method, the step a) comprises mixing HRC or MFC having a Schopper-Riegler (SR) number >70, preferably >80, and more preferably >90, as measured according to the standard ISO 5267-1, with compression refined cellulose pulp having a Schopper-Riegler (SR) number <30, preferably <20, and more preferably <15, as measured according to the standard ISO 5267-1.

In some embodiments, step a) comprises mixing, in aqueous suspension,
50-99 wt % HRC having a Schopper-Riegler (SR) number >70, as measured according to the standard ISO 5267-1, with
1-50 wt % of compression refined cellulose pulp having
   a Schopper-Riegler number (SR)<30, as measured according to the standard ISO 5267-1, and
   a water retention value (WRV)>120%, as measured according to the standard ISO 23714,
based on the total dry weight of the HRC composition.

In some embodiments, the method further comprises co-refining the HRC with the compression refined cellulose pulp.

In some embodiments, the web formation in step b) comprises wire forming and dewatering, casting, coating or wet laid process. In some embodiments, the web formation in step b) comprises wire forming and dewatering, preferably in a papermaking machine, such as a Fourdrinier type papermaking machine.

In some embodiments, the drying in step c) is performed at a temperature above 50° C., preferably above 70° C., more preferably above 90° C. The drying temperature refers to the temperature in HRC paper or film. The drying source may have a much higher temperature than the actual film. Drying means that solid content of the HRC paper or film is at least 80 wt %, preferably at least 85 wt % and more preferably at least 90% after the drying.

In some embodiments, the obtained HRC paper or film is further subjected to calendering to a PPS surface smoothness <5 μm, preferably <4 μm, and more preferably <3 μm, as determined according to ISO 8791-4:2007.

The present disclosure is based on the inventive realization that compression refined cellulose pulp can be used to improve the mechanical properties of HRC papers or films, while still maintaining the good gas barrier properties characteristic to HRC papers or films without added fibers.

According to a fifth aspect illustrated herein, there is provided the use of compression refined cellulose pulp as a dewatering agent or as a strength enhancement agent in an HRC composition for preparation of barrier papers or films.

In some embodiments, the compression refined cellulose pulp is further defined as described above with reference to the first aspect.

In some embodiments, the HRC composition of the fifth aspect is an HRC composition as described above with reference to the first aspect.

The term “wt %” as used herein (e.g. with reference to pulp compositions or pulp fractions) refers to weight percent based on the total dry weight of the composition.

The term “consistency” as used herein (e.g. with reference to pulp compositions or pulp fractions) refers to weight percentage of dry solid substances in the composition based on the total weight of the composition.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### EXAMPLES

Various thin barrier films, 30 g/m², were prepared using wet laid (drainage through membrane) method resembling Fourdrinier papermaking technique and cast forming, respectively. The films were dried on a rotary drum at 80° C.

Highly refined cellulose pulp (HRC) was prepared from 100% kraft pulp refined to a Schopper Riegler (SR) value about 95 determined according to the ISO 5267-1 standard. The pH of the pulp was 7.2, the amount of long (>0.2 mm) fibers was 19.8 million fibers/g, and the Fines A content was 47% and fines B content was 47% as determined by using an FS5 fiber analyzer (Valmet) at 5 μm setting.

The compression refining was made on bleached kraft pulp providing the following properties.

Compression refined cellulose pulp was prepared by compression refining of bleached kraft pulp. Unrefined bleached kraft pulp was used as comparison. The analysis of the unrefined and compression refined bleached kraft pulp is presented in Table 1. The compression refining did not affect surface fibrillation nor the drainage resistance. Fines A and Fines B contents remained on low levels, whereas fiber curl increased significantly suggesting that fiber wall was damaged.

TABLE 1

| | | Compression |
|---|---|---|
| | Unrefined pulp | refined pulp |
| SR value | 11.5 | 12 |
| WRV, % | 107 | 181 |
| Fiber length Lc(n) ISO, FS5, mm | 1.33 | 1.26 |
| Fiber curl FS5, % | 27.1 | 34.7 |
| Fiber width FS5, μm | 17.1 | 18.8 |
| Fibrillation FS5, % | 0.99 | 1.15 |
| Fines A FS5, % | 10.2 | 11.3 |
| Fines B FS5, % | 13.4 | 11.2 |
| Kink FS5, 1/m | 1948 | 1814 |

### Example 1 (Comparative)—100% Highly Refined Kraft Pulp

A thin 33.8 g/m² barrier film was prepared from 100% highly refined bleached kraft as described above. The film was analyzed and the results are set out in Table 2. The obtained film had good oxygen barrier properties but the furnish shows very high drainage resistance.

### Example 2 (Comparative)—Addition of 10% Slightly Refined Bleached Kraft Pulp

10 wt % of never dried bleached softwood kraft pulp refined with lab Voith-Sulzer at 100 kWh/t, to a Schopper Riegler (SR) value of 19 was added to the same type of highly refined bleached kraft pulp as used in Example 1. A thin 30.9 g/m² barrier substrate was prepared. The thin substrate was subjected to dewatering and drying. The film was analyzed and the results are set out in Table 2. The dewatering rate was not significantly affected and density was significantly reduced. The reduced density is associated with a clear deterioration in gas barrier properties as compared to Example 1.

### Example 3—Addition of 10% Compression Refined Pulp

10 wt % of a compression refined pulp was added to the same type of highly refined bleached kraft pulp as used in Example 1. A thin 30.8 g/m² barrier substrate was prepared. The thin substrate was subjected to dewatering and drying. The film was analyzed and the results are set out in Table 2. The results show that the drainage resistance was reduced, but also that the density was significantly higher compared to Example 2. Gas barrier properties were on good level.

### Example 4—Addition of 20% Compression Refined Pulp

20 wt % of a compression refined pulp was added to the same type of highly refined bleached kraft pulp as used in Example 1. A thin 31.5 g/m² barrier substrate was prepared. The thin substrate was subjected to dewatering and drying. The film was analyzed and the results are set out in Table 2. The results show that the drainage resistance was significantly reduced, whereas also density is clearly higher compared to comparative Example 2. Gas barrier properties were still on a good level, despite the high amount of added compression refined pulp.

TABLE 2

| | | | Dewatering | | | |
|---|---|---|---|---|---|---|
| | Basis | | time, | Tear | Tensile | |
| | weight | Density | s/g of dry | index | index | OTR 23/50 |
| | g/m² | kg/m³ | fiber in the film | mNm²/g | Nm/g | cc/m²/24 h |
| Example 1 | 33.8 | 952 | 627 | 1.21 | 114 | 9.0 |
| Example 2 | 30.9 | 670 | 642 | N.D. | N.D. | 29.0 |
| Example 3 | 30.8 | 886 | 599 | N.D. | N.D. | 14.8 |
| Example 4 | 31.5 | 845 | 464 | N.D. | N.D. | 16.7 |

Unless specified otherwise, the properties or parameters discussed in the present disclosure are determined according to the following standard methods:

| Property | Method used |
|---|---|
| Grammage | ISO 536: 2012 |
| Density | ISO 534: 2011 |
| Drainability, Schopper-Riegler (SR) | ISO 5267-1 |
| Water retention value (WRV) | ISO 23714 |
| Smoothness PPS 1 MPa | ISO 8791-4: 2007 |
| Tear index | ISO 1974: 2012 |
| Tensile index | ISO 1924-3: 2005 |
| Moisture content | Oven drying |
| Oxygen transmission rate (OTR) | ASTM F1927-98 |

OTR was measured at 23° C. and 50% RH. Instruments from Mocon were used.

1. A highly refined cellulose pulp (HRC) composition for preparation of barrier papers or films, said composition comprising:
50-99 wt % highly refined cellulose having a Schopper-Riegler number (SR)>70, as measured according to standard ISO 5267-1, and
1-50 wt % of compression refined cellulose pulp having
a Schopper-Riegler number (SR)<30, as measured according to the standard ISO 5267-1, and
a water retention value (WRV)>120%, as measured according to standard ISO 23714,
based on a total dry weight of the HRC composition.

2. The HRC composition according to claim 1, wherein the HRC composition is an aqueous suspension.

3. (canceled)

4. The HRC composition according to claim 1, wherein the HRC composition has a Schopper-Riegler (SR) number >20, as measured according to the standard ISO 5267-1.

5. The HRC composition according to claim 4, wherein the HRC composition has a Schopper-Riegler (SR) number <95, as measured according to the standard ISO 5267-1.

6. The HRC composition according to claim 1, wherein the HRC composition comprises in a range of 55-99 wt % of highly refined cellulose, based on the total dry weight of the HRC composition.

7. The HRC composition according to claim 1, wherein the HRC composition comprises in a range of 1-40 wt % of the compression refined cellulose pulp, based on the total dry weight of the HRC composition.

8. The HRC composition according to claim 1, wherein the highly refined cellulose is microfibrillated cellulose (MFC).

9. The HRC composition according to claim 1, wherein the highly refined cellulose is unmodified highly refined cellulose or chemically modified highly refined cellulose, or a mixture thereof.

10. The HRC composition according to claim 1, wherein the highly refined cellulose has a Schopper-Riegler (SR) number >80 as measured according to the standard ISO 5267-1.

11. The HRC composition according to claim 1, wherein said compression refined cellulose pulp has a Schopper-Riegler (SR) number <20, as measured according to the standard ISO 5267-1.

12. The HRC composition according to claim 1, wherein said compression refined cellulose pulp has a water retention value (WRV)>130% and <210%, as measured according to the standard ISO 23714.

13. (canceled)

14. The HRC composition according to claim 1, wherein said compression refined cellulose pulp has a fiber curl value >10%, as determined using a FS5 fiber analyzer (Valmet).

15. The HRC composition according to claim 1, wherein said compression refined cellulose pulp has a mean fiber length (Lc(n) ISO) in a range of 0.2-4 mm, as determined using a FS5 fiber analyzer (Valmet).

16. The HRC composition according to claim 1, wherein the HRC composition further comprises a water-soluble polymer selected from a group consisting of: a starch, a polyvinyl alcohol (PVOH), a cellulose derivative, a hemicellulose, a polyacrylamide, a polydiallyldimethylammonium chloride (PDADMAC), a polyvinylamine (PVAm), a polyethyleneimine (PEI), a protein and mixtures thereof.

17. The HRC composition according to claim 16, wherein the HRC composition comprises in the range of 0.1-50 wt % of the water-soluble polymer, based on the total dry weight of the HRC composition.

18. The HRC composition according to claim 1, wherein the HRC composition further comprises a pigment.

19. (canceled)

20. An HRC paper or film comprising the HRC composition according to claim 1.

21. The HRC paper or film according to claim 20, wherein the HRC paper or film has a grammage in a range of 10-100 g/m².

22. The HRC paper or film according to claim 20, wherein the HRC paper or film has a tear index at least 5% higher than a tear index of a corresponding paper or film formed entirely of a same type of highly refined cellulose used in the HRC composition, as measured according to standard ISO 1974.

23. The HRC paper or film according to claim 20, wherein the HRC paper or film has an oxygen transfer rate (OTR), as measured according to standard ASTM F-1927-98 at 50% relative humidity and 23° C., of less than 30 cc/m²/24 h/atm.

24. (canceled)

25. The HRC paper or film according to claim 20, wherein the HRC paper or film has a PPS surface smoothness <5 μm, as determined according to ISO 8791-4:2007.

26. A multilayer material comprising at least:
a substrate layer and
an HRC layer comprising the HRC composition according to claim 1.

27. The multilayer material according to claim 26, wherein the substrate layer is paper or paperboard.

28. (canceled)

29. A method of preparing an HRC paper or film, said method comprising:
a) preparing an aqueous suspension of the HRC composition according to claim 1;
b) forming a web of the aqueous HRC composition; and
c) allowing the web to dry to obtain the HRC paper or film.

30.-33. (canceled)
